(19) United States
(12) Patent Application Publication
(10) Pub. No.: US 2009/0055739 A1
(43) Pub. Date: Feb. 26, 2009

(54) CONTEXT-AWARE ADAPTIVE USER INTERFACE

(75) Inventors: Oscar E. Murillo, Redmond, WA (US); Arnold M. Lund, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/844,308

(22) Filed: Aug. 23, 2007

(51) Int. Cl. G06F 3/00

(52) U.S. Cl. 715/708

(57) ABSTRACT

Technologies, systems, and methods for context-aware adaptation of user interface where monitored context includes ambient environmental and temporal conditions, user state, and the like. For example, when a user has been using an application for a long time, ambient lighting conditions are becoming darker, and the user is inferred to be experiencing increased eye strain and fatigue, the user interface may be adapted by increasing the contrast. Such adaptation may be based on rules, pre-defined or otherwise. The processing of sensor data typically results in context codes and detection of context patterns that may be used to adapt user interface for an optimized user experience.

### BACKGROUND

An effective user interface for a program is one that “fits” the user. When an interface fits the user, they learn the program faster, they perform program tasks more efficiently and effectively, and they are more satisfied with their experience. By far the most common interfaces are static, and at best provide users with alternative means to accomplish their objectives so they can select the one that best fits their needs. But environmental factors, such as ambient lighting conditions, sound levels, etc may adversely affect an otherwise effective user interface. Further, the degree of user fatigue or distraction may also adversely impact an otherwise effective user interface.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide technologies, systems, and methods for context-aware adaptation of user interface where monitored context includes ambient environmental and temporal conditions, user state, and the like. For example, when a user has been using an application for a long time, ambient lighting conditions are becoming darker, and the user is inferred to be experiencing increase eye strain and fatigue, the user interface may be adapted by increasing the contrast. Such adaptation may be based on rules, pre-defined or otherwise. The processing of sensor data typically results in context codes and detection of context patterns that may be used to adapt user interface for an optimized user experience. Further, context patterns may be used to predict user needs over time.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is block diagram showing an example context-aware adaptive user interface processing system.

FIG. 2 is a block diagram showing an example method for adapting a user interface based in a context-aware fashion.

FIG. 3 is a diagram of example UI in two different formats.

FIG. 4 is a diagram of example UI in two different formats.

FIG. 5 is a diagram of example UI in two different formats.

FIG. 6 is a block diagram showing an example computing environment in which the technologies described herein may be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing environment, the environment described is provided as an example and not a limitation. As those skilled in the art will appreciate, the present examples are suitable for application in a variety of different types of computing environments.

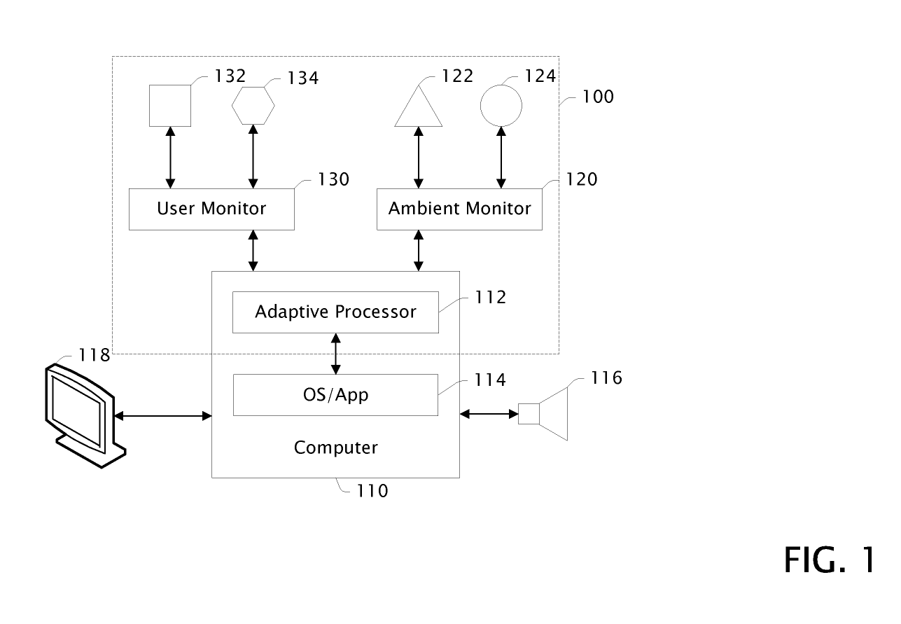

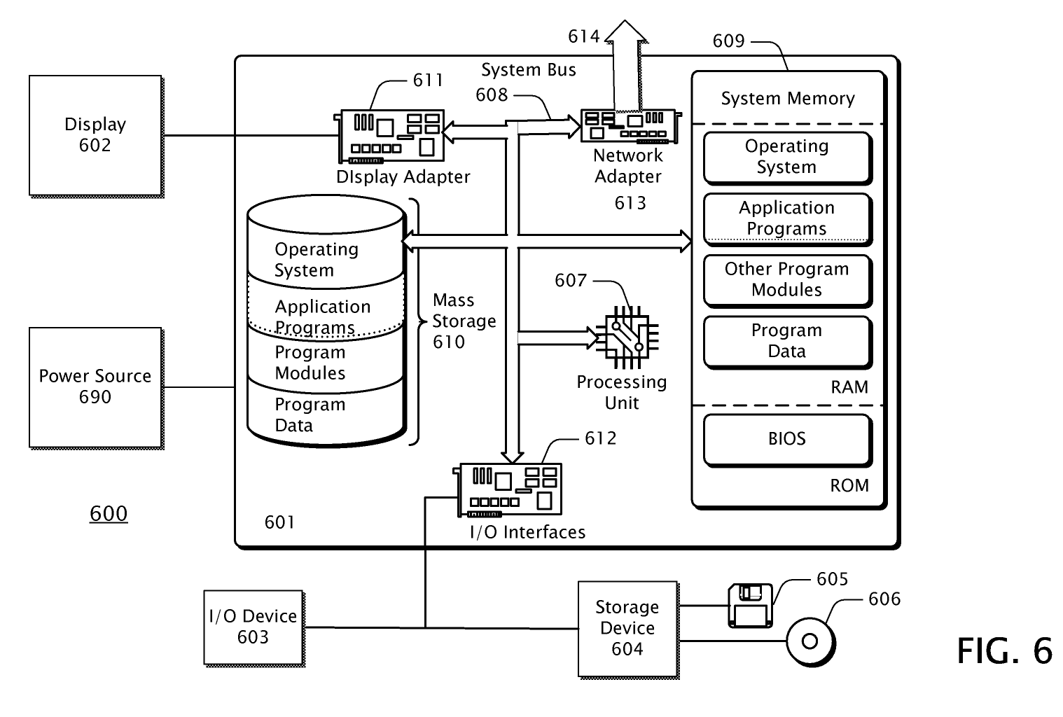

FIG. 1 is block diagram showing an example context-aware adaptive user interface (“UI”) processing (“AUP”) system 100. AUP 100 typically includes an adaptive processor operating on a computer 110 which may be any computing environment 600 such as those described in connection with FIG. 6. Adaptive processor 112 typically interacts with an operating system(s) and/or other application(s) as indicated by block 114 (“APP”) running on computer 110. APP 114 may be any type of operating system, application, program, software, system, driver, script, or the like operable to interact with a user in some manner. Computer 110 typically includes speaker 116 and display 118 such as output device 602 and other output devices described in connection with FIG. 6.

Adaptive processor 112 is typically coupled to user monitor 130 and ambient monitor 120 and the like, each coupled to various sensors, for monitoring the context of the user, the state of the user, etc. Such monitors and their respective sensors may or may not operate on computer 110. User monitor 130 typically monitors a user of APP 114 via various sensors 132 and 134 (“user sensors”) suitable for monitoring user parameters such as facial and expression recognition, input speed and accuracy, voice stress level, input delay, and the like. Ambient monitor 120 typically monitors ambient environmental and temporal conditions via various sensors 122 and 124 (“ambient sensors”) suitable for monitoring ambient parameters such as time durations, lighting levels, sound and noise levels, and the like. Sensors for other aspects of the user and the surroundings may alternatively or additionally be employed. Any number of sensors may be used in conjunction with monitors 120 and 130.

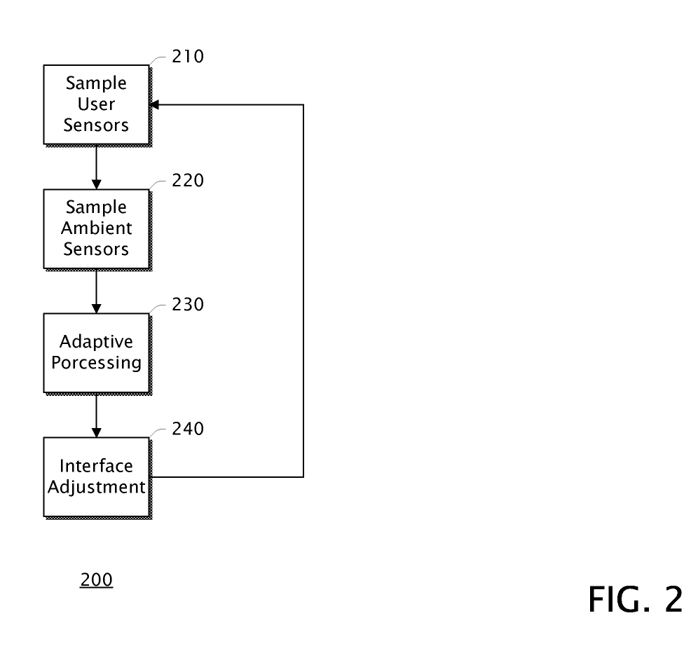

FIG. 2 is a block diagram showing an example method 200 for adapting a user interface based in a context-aware fashion. Method 200 takes into account context or conditions including ambient conditions and the user's state. Further, method 200 may adapt a UI based not just on static conditions, but on patterns in those conditions. For example, as time passes, ambient light decreases, and user input rates slow, it can be inferred that the user is growing fatigued and the UI can be adapted accordingly. AUP system sensor data may be acquired based on a set of pre-defined rules, the data being processed into a set of context codes that represent context patterns over time. The AUP system may make use of these context codes to adapt UI or, alternatively, applications may access the context codes themselves and modify their own UI based on the context codes.

Block 210 typically indicates acquiring data from user sensors, typically via a user monitor or the like such as that described in connection with FIG. 1. Data from all user sensors may be acquired or, alternatively, selectively based upon rules. Once user sensor data has been acquired, method 200 typically continues at block 220.

Block 220 typically indicates acquiring data from ambient sensors, typically via an ambient monitor or the like such as that described in connection with FIG. 1. Data from all ambient sensors may be acquired or, alternatively, selectively based upon rules. Once ambient sensor data has been acquired, method 200 typically continues at block 230.

Block 230 typically indicates processing sensor data. Sensor data may be processed based on rules and/or context codes generated. Context patterns may be detected or determined based on current UI settings and/or sensor data and/or previously detected context patterns. Context codes and/or patterns may be stored in a data store. Further, user state may also be inferred based at least in part on sensor data, such as eye strain, fatigue, degree of task focus, cognitive load, and the like. Such user state may be inferred based at least in part on user sensor data, ambient sensor data, context data, and/or context patterns, or the like. Further, context patterns may be processed to predict user needs. Once processing and the like is complete, method 200 typically continues at block 240.

Block 240 typically indicates adapting UI based on the processing and the like indicated by block 230. Once the UI is adapted, method 200 typically continues at block 210 to repetitively monitor sensors, process data, and adjust UI. In one example, method 200 is explicitly ended by user choice or the like.

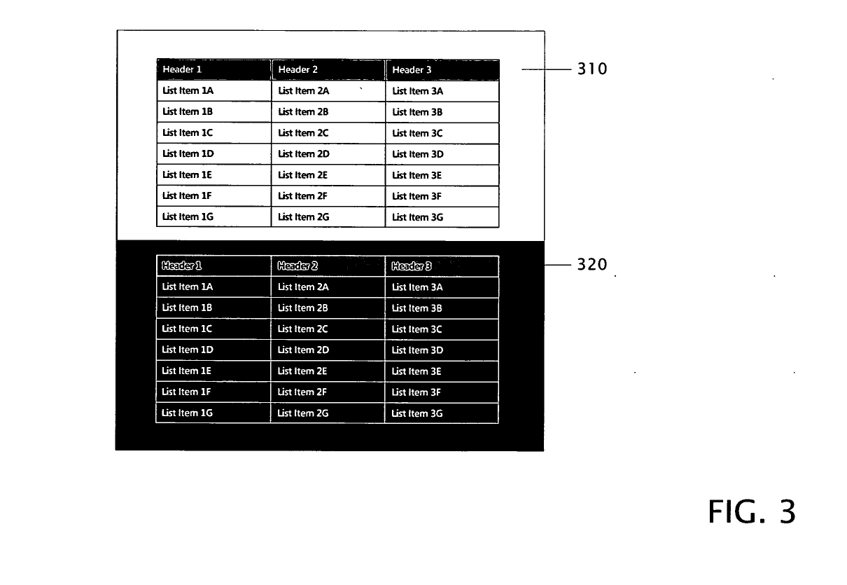

FIG. 3 is a diagram of example UI in two different formats 310 and 320. UI 310 depicts a table displayed in a UI optimized (dark text on white background) for a well-illuminated conditions. UI 320 depicts the same table adapted (white text on a dark background) for dark conditions. Such an example context-aware UI adaptation may be made over time as ambient lighting conditions change from light to dark. Many other adaptations may be made using an AUP system and method.

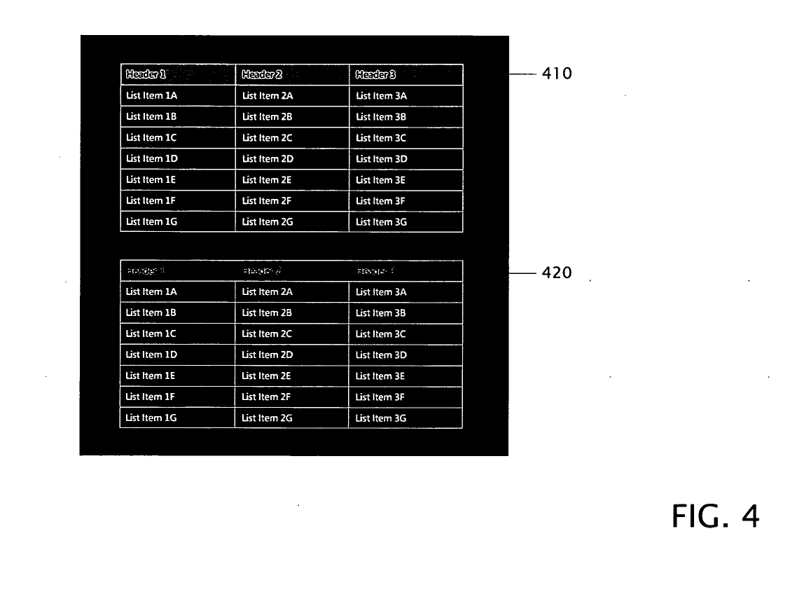

FIG. 4 is a diagram of example UI in two different formats 410 and 420. UI 410 depicts a table displayed in a high-contrast format. UI 420 depicts the same table adapted to a low-contrast format. Such an example context-aware UI adaptation may be made over time to compensate for inferred eye strain and/or fatigue. Many other adaptations may be made using an AUP system and method.

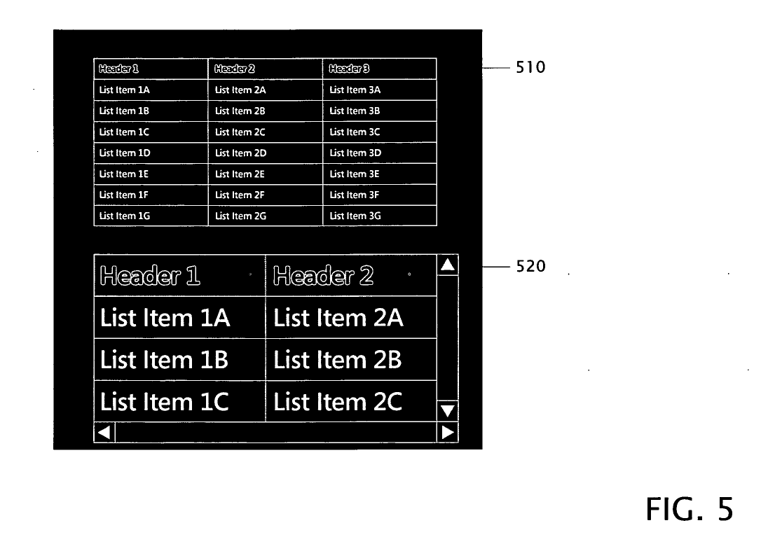

FIG. 5 is a diagram of example UI in two different formats 510 and 520. UI 510 depicts a table displayed using a smaller font size. UI 520 depicts the same table displayed in a larger font size. Such an example context-aware UI adaptation may be made over time to compensate to inferred eye strain, fatigue, and/or changes in cognitive load. Many other adaptations may be made using an AUP system and method.

FIG. 6 is a block diagram showing an example computing environment 600 in which the technologies described herein may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 600 typically includes a general-purpose computing system in the form of a computing device 601 coupled to various components, such as peripheral devices 602, 603, 604 and the like. System 600 may couple to various other components, such as input devices 603, including voice recognition, touch pads, buttons, keyboards and/or pointing devices, such as a mouse or trackball, via one or more input/output (“I/O”) interfaces 612. The components of computing device 601 may include one or more processors (including central processing units (“CPU”), graphics processing units (“GPU”), microprocessors (“μP”), and the like) 607, system memory 609, and a system bus 608 that typically couples the various components. Processor 607 typically processes or executes various computer-executable instructions to control the operation of computing device 601 and to communicate with other electronic and/or computing devices, systems or environment (not shown) via various communications connections such as a network connection 614 or the like. System bus 608 represents any number of several types of bus structures, including a memory bus or memory controller, a peripheral bus, a serial bus, an accelerated graphics port, a processor or local bus using any of a variety of bus architectures, and the like.

System memory 609 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 609 typically stores data, computer-executable instructions and/or program modules comprising computer-executable instructions that are immediately accessible to and/or presently operated on by one or more of the processors 607.

Mass storage devices 604 and 610 may be coupled to computing device 601 or incorporated into computing device 601 via coupling to the system bus. Such mass storage devices 604 and 610 may include non-volatile RAM, a magnetic disk drive which reads from and/or writes to a removable, non-volatile magnetic disk (e.g., a “floppy disk”) 605, and/or an optical disk drive that reads from and/or writes to a non-volatile optical disk such as a CD ROM, DVD ROM 606. Alternatively, a mass storage device, such as hard disk 610, may include non-removable storage medium. Other mass storage devices may include memory cards, memory sticks, tape storage devices, and the like.

Any number of computer programs, files, data structures, and the like may be stored in mass storage 610, other storage devices 604, 605, 606 and system memory 609 (typically limited by available space) including, by way of example and not limitation, operating systems, application programs, data files, directory structures, computer-executable instructions, and the like.

Output components or devices, such as display device 602, may be coupled to computing device 601, typically via an interface such as a display adapter 611. Output device 602 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 601 to interact with human operators or other machines, systems, computing environments, or the like. A user may interface with computing environment 600 via any number of different I/O devices 603 such as a touch pad, buttons, keyboard, mouse, joystick, game pad, data port, and the like. These and other I/O devices may be coupled to processor 607 via I/O interfaces 612 which may be coupled to system bus 608, and/or may be coupled by other interfaces and bus structures, such as a parallel port, game port, universal serial bus (“USB”), fire wire, infrared (“IR”) port, and the like.

Computing device 601 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 601 may be coupled to a network via network adapter 613 or the like, or, alternatively, via a modem, digital subscriber line (“DSL”) link, integrated services digital network (“ISDN”) link, Internet link, wireless link, or the like.

Communications connection 614, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 690, such as a battery or a power supply, typically provides power for portions or all of computing environment 600. In the case of the computing environment 600 being a mobile device or portable device or the like, power source 690 may be a battery. Alternatively, in the case computing environment 600 is a desktop computer or server or the like, power source 690 may be a power supply designed to connect to an alternating current (“AC”) source, such as via a wall outlet.

Some mobile devices may not include many of the components described in connection with FIG. 6. For example, an electronic badge may be comprised of a coil of wire along with a simple processing unit 607 or the like, the coil configured to act as power source 690 when in proximity to a card reader device or the like. Such a coil may also be configure to act as an antenna coupled to the processing unit 607 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 602, I/O device 603, or many of the other components described in connection with FIG. 6. Other mobile devices that may not include many of the components described in connection with FIG. 6, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A context-aware adaptive user interface processing system comprising:
an adaptive processor;
a user monitor coupled to the adaptive processor;
one or more user sensors coupled to the user monitor;
an ambient monitor coupled to the adaptive processor; and
one or more ambient sensors coupled to the ambient monitor,
wherein the adaptive processor acquires sensor data from the user sensors and the ambient sensors and generates context codes based at least in part on the sensor data.

2. The system of claim 1 wherein the context codes are made available to an application or an operating system.

3. The system of claim 1 wherein a user interface is adapted based at least in part on the context codes.

4. The system of claim 1 wherein the adaptive processor generates context patterns based at least in part on the context codes, the context patterns being made available to an application or operating system.

5. The system of claim 1 wherein the adaptive processor makes an inference about a state of a user based at least in part on the sensor data.

6. The system of claim 1 wherein the ambient sensors detect ambient lighting conditions.

7. The system of claim 1 wherein the ambient sensors detect ambient noise levels.

8. The system of claim 1 wherein the user sensors detect user data suitable to infer user eye strain or fatigue.

9. The system of claim 1 wherein the ambient sensors detect a duration of time a user has been using an operating system.

10. A method for adapting a user interface, the method comprising:
sampling ambient sensor data;
processing the ambient sensor data; and
generating context codes based on at least in part of the ambient sensor data wherein a user interface is adapted based on the context codes.

11. The method of claim 10 wherein the sampling includes sampling user sensor data.

12. The method of claim 11 wherein the processing includes processing the user sensor data.

13. The method of claim 12 wherein the generating includes generating the context codes based at least in part on the user sensor data.

14. The method of claim 10 further comprising generating context patterns based at least in part on the context codes.

15. The method of claim 10 further comprising inferring a user state.

16. The method of claim 10 wherein the ambient sensors detect a duration of time a user has been using an operating system.

17. The method of claim 10 wherein the ambient sensors detect ambient lighting conditions.

18. The method of claim 10 the ambient sensors detect ambient noise levels.

19. A computer-readable medium embodying computer-executable instructions for performing a method, the method comprising:
sampling ambient sensor data;
processing the ambient sensor data; and
generating context codes based on at least in part of the ambient sensor data wherein a user interface is adapted based on the context codes.

20. The computer-readable medium of claim 19, the method further comprising generating the context codes based at least in part on user sensor data.
